(19) United States
(12) Patent Application Publication
(10) Pub. No.: US 2020/0376754 A1
(43) Pub. Date: Dec. 3, 2020

(54) POST -EXPOSURE DEVICE FOR PRODUCTS PRODUCED BY STEREOLITHOGRAPHY, AND METHOD FOR SOLIDIFYING PRODUCTS PRODUCED BY STEREOLITHOGRAPHY

(71) Applicant: BEGO BREMER GOLDSCHLÄGEREI WILH. HERBST GMBH & CO. KG, Bremen (DE)

(72) Inventor: Heniz Lambrecht, Bremen (DE)

(73) Assignee: BEGO BREMER GOLDSCHLÄGEREI WILH. HERBST GMBH & CO. KG, Bremen (DE)

(21) Appl. No.: 15/998,900

(22) PCT Filed: Feb. 6, 2017
(86) PCT No.: PCT/EP2017/052511

§ 371 Date: Aug. 16, 2018

(30) Foreign Application Priority Data
Feb. 17, 2016 (DE) 10 2016 102 811.8

(51) Int. Cl. B29C 64/188; B29C 64/129; B29C 71/04; B29C 35/08; B29C 64/20; B33Y 40/20; B33Y 10/00

(52) U.S. Cl. CPC B29C 64/188; B29C 64/129; B29C 71/04; B29C 2035/0822; B29C 64/20; B33Y 40/20; B33Y 10/00; B29C 35/0805

(57) ABSTRACT

A post-exposure apparatus is disclosed, comprising a reception apparatus for receiving a product produced by stereolithography, a radiation apparatus for irradiating a product received in the reception apparatus, and a movement apparatus, coupled between the reception apparatus and the radiation apparatus, for producing a relative movement between the product received in the reception apparatus and the radiation apparatus. The movement apparatus comprises a first guide apparatus for guiding the relative movement along a first guide path and a second guide apparatus for guiding the relative movement along a second guide path that differs from the first guide path.

### CROSS-REFERENCE TO FOREIGN PRIORITY APPLICATION

The present application claims the benefit under 35 U.S.C. §§ 119(b), 119(e), 120, 121, 365(c), and/or 386(c) of PCT/EP2017/052511 filed Feb. 6, 2017, which claims priority to German Application DE 102016102811.8 filed Feb. 17, 2016.

### FIELD OF THE INVENTION

The invention relates to a post-exposure apparatus, comprising a reception apparatus for receiving a product produced by stereolithography, a radiation apparatus for irradiating a product received in the reception apparatus and a movement apparatus, coupled between the reception apparatus and the radiation apparatus, for producing a relative movement between the product received in the reception apparatus and the radiation apparatus.

### BACKGROUND OF THE INVENTION

Products produced by stereolithography have their origins in building illustrative models and prototypes. In the meantime, stereolithographic production has advanced so far that ready-to-use products can be produced in individual production and relatively small- to mid-batch production by means of stereolithography. In this respect, the term “rapid prototyping,” as used originally, no longer reproduces the full spectrum of application of stereolithography.

Within the meaning of this description and the claims, stereolithography should be understood to mean methods in which a product is produced from an initial material by means of selective irradiation. Here, a selective irradiation should be understood to mean that predetermined regions of the initial material are irradiated and, as a result thereof, only these predetermined regions are cured by the irradiation, whereas other regions are spared from the irradiation and are not cured. Here, the irradiation can immediately lead to a curing, or it may modify the material in such a way that curing is caused in subsequent treatment processes, which then capture the previously, selectively irradiated regions.

Typically, there is a layer-by-layer construction of the product to be produced in stereolithographic methods. Here, a selective irradiation is undertaken in predetermined regions within a layer, said regions corresponding to the cross-sectional area of the product to be produced in this layer and this process being repeated a number of times with layers building on one another, wherein the respectively newly built layer is connected to the previously produced layer in the region of the predetermined regions to be cured.

A many-times used stereolithographic method uses a light-curing polymer as a curable material, i.e., a material which is present in a non-cross-linked or only partly cross-linked form (for example, as a monomer), for example, in liquid form, and which cross-links and cures as a result thereof by way of the exposure. Here, cross-linking can proceed, in particular, as a chemical reaction within the meaning of a polymerization. In practice, such methods are implemented by virtue of the curable liquid being provided as a bath and exposure being carried out on or below a platform by means of a selectively controlled laser beam or a masked exposure. Then, there can be layer-by-layer production by lowering this platform into this liquid bath if the irradiation is implemented from above. Accordingly, conversely, there can be layer-by-layer production by lifting this platform if the irradiation is implemented from below through a radiation-transmissive base wall of the bath.

As a rule, products produced by stereolithography can be regularly produced with a structural solidity from the production process carried out in this way, and can be removed therefrom, in a manner which generally allows handling of the produced product without the risk of damage. However, it was found that products produced in this way do not have an ideal solidity within the meaning of a solidity that can be achieved in the ideal case by the employed material. This lies in the fact that the selective exposure often has not led to complete, maximum solidification or curing in an ideal manner. As a consequence of the incomplete crosslinking, there still are monomer components present in the component. This residual monomer content is problematic for certain applications, for example, if there is a medical use, since, although the cross-linked polymer often has the desired biocompatible properties, this is not the case for the non-cross-linked monomer or incompletely cross-linked monomer chains.

According to the discovery of the inventors, the production duration moreover is a factor that restricts the breadth of use of such stereolithographic apparatuses. The production duration is not further reducible, inter alia, on account of the necessary exposure times, in order to obtain a solidity of the produced product that is sufficient for the purpose of use.

Subjecting products produced by stereolithography to a post-exposure is known. In the case of such a post-exposure, the product removed from the liquid bath is post-exposed in a subsequent process. As a rule, this post-exposure is implemented in a non-selective manner, i.e., all regions or a plurality of regions of the product produced by stereolithography, and also regions outside of the product that surround these regions of the product, are irradiated together by means of an irradiation apparatus. Since the product during the post-exposure is already produced with its desired geometry and no longer situated in the liquid bath and since no liquid remains should adhere thereto either, the product can be irradiated overall and quickly by way of such a non-selective post-exposure. This is intended to bring about a solidification of the product overall and, where possible, a solidification to an ideal solidity.

However, a problem with the post-exposure is that the post-exposure is carried out on the completely finished product. Therefore, the radiation can primarily reach the surface of the product and not, however, structures lying deeper down. As a consequence, only insufficient solidification can be obtained in the interior of the produced product by means of the post-exposure, in particular, at points at which there is a great material strength of the product.

A further problem of the post-exposure lies in the fact that the irradiation apparatus does not reach all surface regions of the product uniformly, and so there is uneven irradiation in respect of the surface of the product, too, and different amounts of irradiation arrive at different surface regions. Firstly, the amount of irradiation, which is already non-uniform over the surface and also the amount of irradiation that is not uniform below the surface when comparing the surface to lower-lying regions of the product, leads to the irradiation overall only being able to be carried out as a compromise. The result of the compromise are regions that have not experienced an ideal complete solidification or regions which have received an excess amount of irradiation and turn brittle thereby, or both.

A further disadvantage that may arise during the post-exposure and consequently post-solidification or post-curing of products, which were produced by a stereolithographic method, is warpage or the production of internal stresses in the component. In principle, a shrinkage of the component accompanies the post-exposure in most materials that are used for the stereolithographic production method. This shrinkage can be predetermined before the production process and can be taken into account accordingly during the selective irradiation such that the geometry of the product after the post-exposure corresponds to a desired setpoint geometry. However, an uneven post-exposure within the meaning of a locally increased post-exposure during the post-exposure process or a locally increased amount of radiation in terms of the sum thereof after the post-exposure process may lead to an occurrence of uneven shrinkage of various regions of the component and this may result in warpage of the product or this may produce internal stresses within the component. It is an object of the invention to reduce the risk of such warpage and such internal stresses.

DE 202007004266U1 has disclosed an apparatus for curing dental material by means of light. This apparatus is used to cure a molded body which, for example, is formed as an impression or as a model and which has not experienced pre-curing by selective irradiation and, consequently, does not experience post-exposure but a first exposure. Unlike in the post-exposure sought-after according to the invention, the typical problems of a post-exposure do not occur in such a first exposure, it being possible to trace back the problems of the post-exposure to a partly inadequate, insufficient irradiation during the selective first exposure, which is, however, locally restricted to certain regions. DE 202007004266U1 proposes exposure by means of two radiation sources, one radiation source of which emitting light of one or more wavelength regions and the other radiation source emitting thermal radiation and, optionally, visible light.

WO2015/15314A1 has disclosed a light curing furnace embodied for curing surface coatings on products produced by stereolithography. Although this method relates to an exposure that is carried out subsequently within the meaning of an exposure after the stereolithographic selective exposure process, here, too, a material, specifically the coating, is, however, exposed for the first time and not post-exposed. To this end, the light curing furnace is equipped with one or more lamps for curing the surface layer.

Compared to this prior art known in advance, the invention relates to a post-exposing unit which, within the meaning of the invention, is understood to mean an apparatus that is embodied and suited to once again expose, i.e., post-expose, a material and a product formed from the material, which had already previously been subjected to an exposure and curing caused thereby, in order to complete the initiated curing process. In contrast to the prior art explained above, curing only a surface layer is not sought after in this case, nor is it sought after to cure a completely uncured product.

According to the discovery of the inventor, the use of the post-exposure apparatus according to the invention or of the post-exposure method according to the invention also allows an acceleration of the production process. On account of the very uniform post-exposure that is achievable by way of the invention, an entire production process is facilitated, in which the selective exposure during the production of the stereolithographic product in the stereolithography appliance can be carried out with only a low exposure intensity and consequently only a low degree of solidification. The product produced in such a way by stereolithography then only has sufficient solidity for handling after the selective exposure; however, it can be sufficiently and homogenously solidified in the post-exposure by way of a nonselective exposure. As a result of this, occupancy of the stereolithography apparatus can be reduced in time or the stereolithographic production method in this apparatus can be shortened.

The prior art has disclosed measures to remedy these disadvantages. Firstly, it is known to post-expose the products by an irradiation apparatus with a multiplicity of radiation sources, wherein these multiplicity of radiation sources emit the radiation onto the product from a corresponding multiplicity of different directions. Thus, for example, the product can be arranged in an interior, which is bounded by walls, and the walls can be equipped with a matrix of a plurality of radiation sources, for example LEDs, such that an action of the irradiation from virtually all sides is achieved. However, a disadvantage of this method is that although the method achieves radiation acting largely on all surface regions, the radiation dose acting on the product overall is high on account of the multiplicity of radiation sources and hence the irradiation intensity overall has to be low. As a result of this, penetration of the radiation into the interior of the product is virtually not achieved, and so this does not solve the problem of the uneven solidification of the surface at lower-lying regions. Additionally, a non-uniform amount of irradiation frequently enters at different surface regions in such apparatuses with a multiplicity of irradiation sources since, depending on the geometry of the product, a different number of irradiation sources are aligned on the surface sections. Surface regions that are shadowed or partly covered are only reached by individual radiation sources, whereas other, more exposed surface regions are reached by a multiplicity of radiation sources. Thus, even though virtually all surface regions are irradiated using such a procedure, the amount of irradiation at the surface is very different in regions according to the discovery of the inventors, leading to local brittle areas or locally insufficient solidification, even at the surface.

To remedy this, arranging the product on rotary plates is known, for example from DE 68929423 T2. Here, the product is placed on the rotary plate and uniformly rotated with the rotary plate. This measure is intended to increase the irradiation uniformity. However, according to the discovery of the inventor, even this measure does not achieve a sufficiently uniform irradiation at the surface that is required for good product properties, and the problem of the large difference between the amount of irradiation at the surface in comparison with the depth of the product is not removed.

WO 2010/036203 has furthermore disclosed a method in which a component is placed into a container that is filled with liquid and that has mirrored container sides. In turn, this should homogenize the amount of irradiation and achieve a more uniform amount of irradiation on the regions of the product. However, this measure cannot lead to a satisfactorily solidified product for demanding use purposes either, since, here too, some surface regions are irradiated more intensely than others and, overall, the surface experiences a higher amount of irradiation than lower-lying regions of the product. Improvements to such devices and methods was desired.

### SUMMARY OF THE INVENTION

The invention is based on the object of improving the stereolithographic production process over the prior art in such a way that products can be produced with an improved solidification compared to the prior art.

According to a first aspect of the disclosed apparatus, this object is achieved by a post-exposure apparatus of the type set forth at the outset, in which the movement apparatus comprises a first guide apparatus for guiding the relative movement along a first guide path and a second guide apparatus for guiding the relative movement along a second guide path that differs from the first guide path.

According to another aspect of the disclosed apparatus, the movement apparatus of the post-exposure apparatus according to the disclosure has a first and a second guide apparatus with a guide along a first and second guide path, respectively. In the disclosed apparatus, the reception apparatus with the product arranged therein is therefore moved along two different guide paths relative to the radiation apparatus by means of the movement apparatus. The actual movement of the reception apparatus with the product arranged therein carried out relative to the irradiation apparatus is, therefore, comprised of a movement along these two guide paths, wherein the actual movement is implemented by superposition, addition, or subtraction of the two movements along the first and second guide paths. In principle, the reception apparatus according to the invention with the product arranged therein can be stationary and the movement apparatus can move the radiation apparatus only in relation to the stationary product along the two guide paths. Alternatively, the radiation apparatus can be installed in stationary fashion on the post-exposure apparatus and the reception apparatus with the product arranged therein can be moved along the first and second guide path by means of the movement apparatus. Finally, the disclosed apparatus also renders it possible to move the reception apparatus with the product arranged therein along the first guide path and the radiation apparatus along the second guide path, or vice versa. The advantage of a combined relative movement between radiation apparatus and reception apparatus with a product along two guide paths, provided according to the invention, arises in all variants.

By way of example, the movement apparatus can be implemented by a rotating drum in which the axis of rotation extends preferably obliquely to the perpendicular or the direction of gravity. Here, the first guide apparatus is formed by bearing the rotating drum about the axis of rotation of the drum. In this case, the second guide apparatus is formed by the outer and base walls of the drum, on which a component inserted into the drum moves in a rolling fashion when the drum rotates. Consequently, the first guide apparatus is a guide apparatus with a defined guide path; in this exemplary embodiment, the second guide apparatus is a guide apparatus with an undefined guide path, i.e., a movement pattern of the product that depends on the surface geometry thereof, center of mass distribution and the rolling behavior within the drum, and on the geometry of the drum surface, and that often brings about a form of movement that is random. In this configuration, the reception apparatus is formed by the product surface itself.

According to a further aspect of the disclosed apparatus, a guide path can be understood to be a closed or an open guide path here, i.e., for example, a circular, figure-of-eight-shaped, ellipsoid guide path as a closed guide path or open guide paths along curves or straight lines or the like. Here, the movement can be embodied as a continuous movement or as a reciprocating movement, wherein, here too, combinations are possible, in which, for example, there is a continuous movement without reversal of direction along the guide path along the first guide path and a movement with a periodically reciprocating movement direction in the case of the second guide apparatus, or vice versa.

The guide path can be embodied as a physically embodied guide unit in the style of a straight or curved rail. However, the guide path can also be embodied as a virtual guiding line, for example by virtue of there being guidance about an axis of rotation at a certain radius and this resulting in a circular guide path.

An advantage achieved according to the disclosed apparatus is that irradiation of the product from all sides can be obtained in a reliable manner by a combination of the relative movement between the radiation apparatus and the product from two guided movements. Here, according to the disclosure, provision can be made for the movement along the first and the second guide paths to be carried out according to a predetermined, precisely set movement relationship and for this to ensure exposure from all sides in a predetermined manner. However, the movement along the first and the second guide paths can likewise be implemented in such a random manner that, in the statistical mean, there is a uniform irradiation of all regions of the product.

An advantage of the disclosed apparatus is that the movement form between radiation apparatus and product does not require an arrangement of radiation sources on a plurality of sides or on all sides but, instead, the post-exposure can be carried out with only a few radiation sources or even with only a single radiation source. As a result, the few radiation sources or the single radiation source can operate overall at a high radiation power, as a result of which deep penetration of the radiation into the product can be achieved. Since this high amount of radiation in each case only occurs in punctiform fashion from one direction on account of the low number of radiation sources possible according to the disclosure and since this direction changes continuously and reliably on all sides, this can homogenize the degree of solidification of the surface at the depth of the product, and so, overall, more uniform solidification of the product is achieved. The few radiation sources or even the single radiation source, which may be facilitated by the post-exposure apparatus according to the disclosure, also avoids an excess post-exposure of exposed surface components which otherwise would be exposed on all sides simultaneously by a plurality of radiation sources and therefore also reduces the solidification differences between the different surface regions of the product.

In principle, it should be understood that the advantages according to the present disclosure are achieved particularly well if the post-exposure apparatus is operated with a few radiation sources or only a single radiation source. However, on account of the improved relative movement according to the invention, advantages are also achieved if use is made of a plurality of radiation sources.

According to a first preferred embodiment, provision is made for the second guide apparatus to be coupled to the first guide apparatus and guided by the first guide apparatus. In this embodiment, the first guide apparatus provides a guide of the relative movement between the reception apparatus and the radiation apparatus in relation to a stationary coordinate system. This means that the first guide apparatus is arranged in stationary fashion in relation to the reception apparatus or the radiation apparatus and the first guide path accordingly extends in stationary fashion relative to the reception apparatus or the radiation apparatus. By contrast, the second guide apparatus is not arranged in stationary fashion but, instead, moves along the first guide path. Consequently, the second guide apparatus is guided by the first guide apparatus and itself already moves relative to the reception apparatus or the radiation apparatus. Correspondingly, the second guide path continuously changes its position, and the relative movement between reception apparatus and radiation apparatus emerges from the movement of the second guide path along the first guide path on the one hand and the movement along the second guide path on the other hand. Correspondingly, the two movements along the first and the second guide path represent a multiplication of the two movements.

In particular, provision can be made here for the first guide apparatus to comprise a first axis of rotation and the second guide apparatus to comprise a second axis of rotation, about which a rotatable bearing is provided between the reception apparatus and the radiation apparatus, and for the second axis of rotation to be guided in a manner rotatable about the first axis of rotation. In this case, the first and the second guide apparatuses are coupled in series and formed by two axes of rotation with, correspondingly, two rotational bearings, wherein the two axes of rotation are not coaxial; i.e., in particular, they extend parallel and at a distance from one another or extend obliquely in relation to one another, wherein obliquely should be understood to mean that the angle between the two axes of rotation is greater than 0° and less than or equal to 90° . An example of such serial coupling of the two guide paths is a platform which rotates about a first axis of rotation by means of a first rotational bearing as a first guide apparatus and on which a second, non-coaxial rotational bearing is assembled about a second axis of rotation as a second guide apparatus, the latter moving with the rotary plate and guiding a second rotational movement superimposed thereon.

According to a further preferred embodiment, alternative thereto, provision is made for the first guide apparatus to be coupled between the reception apparatus and the radiation apparatus, and for the second guide apparatus to be coupled between the reception apparatus and the radiation apparatus, and for the first and second guide apparatuses to directly cause a mutually independent guide between reception apparatus and radiation apparatus. Both guide apparatuses are coupled between the reception apparatus and the radiation apparatus in this embodiment. This should be understood in such a way that both the first and the second guide apparatuses are coupled to the reception apparatus and the radiation apparatus without the respective other guide apparatus being interposed. Therefore, both guide apparatuses are stationary and guide the relative movement along a stationary guide path. Therefore, this results in a relative movement between the reception apparatus and the radiation apparatus, which emerges from an addition of the two movements along the two guide paths. By way of example, such a configuration can arise by virtue of the reception apparatus being guided in two sliding-block guides, which extend in two planes arranged obliquely to one another, or by virtue of the reception apparatus being arranged in a cavity of a sphere which is made to rotate by two roller drives standing obliquely to one another.

Here, it is particularly preferred if this embodiment is developed in such a way that the reception apparatus has a guide element with a spherical guide surface, which surrounds an interior, and a fastening apparatus arranged in the interior for fastening the stereolithographic component, and that the first guide apparatus comprises a first roll which is mounted to be rotatable about a first axis and which is in contact with the spherical guide surface and on which the guide element rolls, and that the second guide apparatus comprises a second roll which is mounted to be rotatable about a second axis that is arranged obliquely to the first axis and which is in contact with the spherical guide surface and on which the guide element rolls. In this embodiment, a spherical surface is used to transfer a driving force from the first roll and a drive force from the second roll. As a result of the rolling movement of the spherical guide surface along both the first and the second rolls, the relative movement is defined and produced between the reception apparatus and the radiation apparatus. The axes of rotation of the first and second rolls are not coaxial and not parallel to one another in this case in order to obtain the desired multi-axis movement of the spherical guide surface and the reception apparatus arranged therein. Here, the radiation apparatus is preferably arranged outside of the interior, which is surrounded by the spherical guide surface, and it radiates into this interior through the spherical guide surface. In particular, the spherical guide surface can have a spherical form or have segments of a spherical form. However, it should be understood that arched surfaces which deviate from a spherical surface with a uniform radius, too, are used as spherical guide surfaces according to the invention.

According to a further preferred embodiment, provision is made for the first guide path to be a first circular path about a first axis of rotation and/or the second guide path to be a second circular path about a second axis of rotation, which extends obliquely to the first axis of rotation. The configuration of the first and the second guide paths as a first and second circular path about a corresponding first and second axis of rotation is particularly preferred since this allows both the guide to be configured to be robust and reliable and a drive for the relative movement along the first and second guide paths in the case of such a configuration to be embodied in a reliable and robust manner by a corresponding rotational drive of a shaft, for example, by way of one or two electric motors. Here, the axes of rotation can be arranged in series or in parallel, and so this results in the coupling of the one axis of rotation with the other axis of rotation or an addition of the two rotational movements as resultant relative movement.

Such a configuration with two axes of rotation can be formed in such a way, for example, that the produced product is fastened to a rotary plate as the reception apparatus which rotates about an axis of rotation and this rotary movement defines the first guide path. By contrast, the second guide apparatus can move the radiation source on a circular path about an axis of rotation, which preferably lies perpendicular to the axis of rotation of the rotary plate and which is aligned in such a way that the radiation direction in each position of the radiation apparatus along this second guide path is directed to the product.

An alternative configuration thereto with two axes of rotation can be formed by virtue of the product once again being arranged on a rotary plate as a reception apparatus rotating about an axis of rotation. This axis of rotation, in turn, can be fastened to a pivot axis which, with a reciprocating movement, pivots to and fro in an angle range of for example −45° to +45° in relation to the direction of gravity and which is perpendicular to the first axis of rotation. In an even further variation of this configuration, the produced product is fastened within a hollow sphere with a transparent outer wall as a reception apparatus and the hollow sphere is placed on two rolls arranged parallel to one another and at a distance from one another and said hollow sphere is made to rotate about a horizontal axis by said rolls. The sphere is superposed laterally with frictional contact with one or two rolls with a vertical axis of rotation and made to rotate about a vertical axis by said rolls, the two rotational movements superimposing additively in this case.

According to a further preferred embodiment, provision is made for the radiation apparatus to have fewer than five, preferably fewer than three, in particular a single radiation source, which, accordingly, irradiates the product from fewer than five, preferably fewer than three, and, in particular, only one direction. As explained above, the special form of movement of the relative movement between the radiation apparatus and the product or the reception apparatus facilitates the use of a few radiation sources and, in particular, a few radiation directions and, as a result thereof, facilitates a complete irradiation of the product with a high radiation intensity from a single radiation source or only a few radiation sources. Here, the radiation sources can be arranged in such a way that they emit the radiation onto the product in the reception apparatus from different directions. Alternatively, the radiation sources can also be arranged in such a way that they irradiate the product received in the reception apparatus in a corresponding direction. The number of radiation directions can correspond to the number of radiation sources or it may be less than the number of radiation sources.

According to a preferred embodiment, the number of activated radiation sources, the radiation direction thereof, the intensity thereof, the intensity profile over time and/or the alignment over time are controlled depending on the geometry and/or the weight of the product. To this end, an irradiation control computer can be present and can be embodied accordingly, said irradiation control computer actuating the radiation sources. To this end, the irradiation control computer can receive position data from a rotational angle sensor or any other sensor that captures the position of the product and undertakes the actuation of the radiation sources according to intensity and the alignment depending on these position data. The geometric data or the weight data of the product can be produced, for example, from CAD data from the construction phase of the product, by way of production data from the stereolithography apparatus, in which the product was produced, or by way of sensor data, such as, e.g., geometric data that were measured by a scan apparatus in the post-exposure apparatus or weight data that were measured by a force sensor in the post-exposure apparatus. The geometric data or weight data produced thus can be guided to the irradiation control computer and the irradiation control computer can be embodied to actuate the radiation sources depending on these geometric data or weight data and, optionally, depending further on position data of the product in the post-exposure unit. Furthermore, the irradiation control computer can be embodied to control the movement of the product in the post-exposure apparatus depending on these data.

According to the invention, a radiation apparatus or a radiation source is understood to mean a functional unit that emits, in directed or undirected fashion, radiation, in particular, which emits radiation in the visible or invisible range. In particular, this can be electromagnetic radiation. The radiation preferably has a wavelength of 250-550 nm, wherein the radiation, in particular, completely fills out this spectral range or comprises one or more wavelength range(s) from this spectral range. The radiation source can preferably have a power from a power range with a lower boundary of 30 W, preferably 50 W, and an upper boundary of 300 W, preferably 250 W. The light output of the radiation source lies at preferably more than 30 lumens/watt, in particular at more than 40 lumens/watt, in the wavelength range between 300 nm and 550 nm. Particularly preferably, one or more mercury-vapor lamps are used as a radiation apparatus, said mercury-vapor lamps having a high radiation power in the wavelength range relevant to most materials used for stereolithography. Furthermore, use can alternatively or additionally be made of one or more flashbulbs, in particular xenon flashbulbs, as radiation source or radiation apparatus.

The post-exposure apparatus according to the disclosure can be further developed by a radiation sensor for capturing the radiation intensity of the radiation source, wherein the radiation sensor is preferably coupled by signaling to a radiation regulation unit, which is embodied to regulate a radiation parameter of the radiation source and coupled by signaling to the radiation source. As explained at the outset, a certain amount of radiation should be regularly sought after for ideal solidification. Here, an amount of radiation should be understood to mean the energy dose, i.e., the amount of energy of the radiation absorbed over a radiation time period per unit mass. In principle, this amount of radiation can be obtained at the same level by virtue of a low radiation intensity acting on the produced product over a long period of time or by virtue of a high radiation intensity acting over a short period of time. According to the disclosure, the relative movement and the option of using only one or a few radiation sources render it possible to use a high radiation intensity of the radiation apparatus and, as a result thereof, obtain a better penetration of the product with the advantage of a homogenization of the solidification between surface and low-lying regions of the product. In order to be able to regulate the radiation intensity or the amount of radiation, it is advantageous to capture the radiation intensity by means of a radiation sensor in order to adjust a predetermined radiation intensity or amount of radiation or in order to regulate a predetermined profile of the radiation intensity. Here, a radiation parameter should be understood to mean the radiation intensity, the wavelength of the radiation and the time profile thereof and the radiation duration.

In particular, the radiation sensor can be arranged here and a control unit coupled to the radiation sensor by signaling can be embodied in such a way that a self-test is carried out and thus the sought-after power and function is checked. Here, the radiation flux density of one or more or all radiation sources of the radiation apparatus is established by means of the radiation sensor and compared to predetermined setpoint values that have to be reached in order to obtain certain operational functions. If these setpoint values are not reached during the self-test, there can be an appropriate adaptation of radiation parameters or else a corresponding fault report can be output to the user via a user interface if a correction by way of an actuation of the radiation apparatus is not possible.

In addition, or as an alternative to such a radiation sensor, it is likewise advantageous if the temperature of the produced products is captured by means of a temperature sensor during the irradiation process. Regularly, a temperature increase of the product that should move within a restricted range for an ideal process run-through may be produced by irradiation. By way of example, the temperature measurement can be carried out by means of a pyrometer, a thermo-element or a thermal imaging camera. The temperature measurement can be carried out by point measurement, particularly if the pyrometer is arranged in stationary fashion in relation to the radiation apparatus and consequently experiences the same relative movement in relation to the reception apparatus. The temperature measurement can also be effected as an area measurement and then flow into the regulation of the irradiation according to the temperature by way of an image evaluation according to a mean value or peak value.

In principle, it is understood that larger objects and objects with a greater wall thickness require a higher amount of radiation than smaller objects or objects with a smaller wall thickness. The different radiation intensities or irradiation durations, which may be necessary for this reason, can be adjustable in manual fashion by a user at the post-exposure apparatus according to the disclosure. However, the amount of radiation, the radiation intensity, or radiation duration can also be set in an automated fashion on the basis of characteristic properties of the product. By way of example, the product can be weighed by a weight sensor integrated into the post-exposure apparatus, and the amount of radiation can be set depending on the weight. Furthermore, the geometry of the product can be captured and evaluated with the aid of a camera, such as a thermal imaging camera, and the amount of radiation can be determined and regulated depending on characteristics such as the surface size of the product or the volume of the product.

Further, it is preferable to control the number of light sources depending on the geometry or the mass or the maximum wall thickness of the product or a combination of these parameters. Consequently, it is possible to activate a different, in particular, smaller number of radiation sources in the case of products with a small surface, small mass, and/or small wall thickness than in the case of a post-exposure of products with correspondingly large mass, large surface, and/or large wall thickness. This process parameter selection can also be carried out manually by a user by way of a user interface or it can be carried out in an automated fashion on the basis of the evaluation of sensor data such as weight data, geometric data, or image data of a camera or the like.

According to a further preferred embodiment, provision is made for the movement apparatus to comprise a drive apparatus for moving the reception apparatus along the first and the second guide paths. The movement along the first and the second guide paths can progress in automated fashion by means of such a movement apparatus. In particular, it is possible to consider an electric drive, which produces the movement along the first guide path, and, optionally, the second guide path by way of appropriate coupling.

Here, it is particularly preferred if the drive apparatus comprises a drive unit, a first transmission unit for coupling the drive unit to the reception apparatus for a movement along the first guide path and a second transmission unit for coupling the drive unit to the reception apparatus for a movement along the second guide path may be provided, wherein the first and/or second transmission unit is preferably switchable between at least two different transmission ratios for changing the movement speed of the reception apparatus along the first and/or second guide path. According to this development form, use is made of a single drive unit in order to produce the movement along the first and along the second guide path. To this end, the drive unit is mechanically coupled to a first transmission unit and a second transmission unit, wherein the first transmission unit produces the movement along the first guide path proceeding from the drive unit and the second transmission unit produces the movement along the second guide path proceeding from the drive unit. By way of example, the transmission units can be embodied by swivel levers, lever transmissions, gear transmissions, roller transmissions, or the like. In this case, the first and second transmission units can be embodied completely independently of one another and can be, respectively, directly coupled to the drive unit or be embodied in such a way that parts of the transmission path of the first and second transmission units are implemented by common transmission elements and other parts of the transmission path are implemented by individual transmission elements of the first and/or the second transmission unit.

As an alternative thereto, provision is made according to another preferred embodiment for the drive apparatus to comprise a first drive unit for moving the reception apparatus along the first guide path and a second drive unit for moving the reception apparatus along the second guide path. In this embodiment, provision is made of two separate drive units which produce, respectively, independently of one another, the movement along the first guide path on the one hand and along the second guide path on the other hand. While the movement ratio along the first to the second guide path can be set in the embodiment explained above by an appropriate change in the transmission ratios of the first and/or the second transmission unit in relation to one another, this embodiment easily allows direct actuation of the first drive unit and/or the second drive unit in order to set the movement ratio along the first to the second guide path. Thus, the second guide path can be passed over at a higher speed than the first guide path in order to obtain certain movement patterns of the relative movement between radiation source and reception apparatus; likewise, the two guide paths can be passed over at the same speed and the speed difference can be set in order to obtain other, advantageous movement patterns.

Here, the post-exposure apparatus can be further developed by virtue of providing a drive control unit which is coupled by signaling to the first and/or the second drive unit and which is embodied to control the speed of the first and/or the second drive unit, in particular independently of one another. By means of such a drive control unit, it is possible to control the movement along the first and/or the second guide path in respect of its speed and direction in order to produce different movement patterns by setting a different speed ratio along the first to the second guide path or in order to produce a movement that is faster or slower overall. In particular, such a drive control unit can be embodied to regulate the rotational speed of an electric motor serving as a drive unit.

The post-exposure apparatus according to the present disclosure can be developed further by virtue of the movement apparatus being embodied in such a way that the difference between the first and the second guide path is adjustable, in particular by virtue of the first guide path being defined by a first direction and the second guide path being defined by a second direction that is at an angle of between 0 and 180° in relation to the first direction, and this angle being adjustable. According to this development, the movement apparatus is embodied in such a way that the difference between the first and second guide path is adjustable, i.e., in particular, the difference caused by the profile of the first and second guide path in the form of an alignment of the plane in which the first or second guide path extends, a direction of the first or second guide path or the specific extent of the guide paths itself is influenced. According to the disclosure, this can be carried out, for example, in such a way that the oblique angle at which two axes of rotation, which form the first and second guide apparatuses, are, in respect to one another, adjustable. Here, the setting can be carried out manually by a user by providing a corresponding mobility of the two axes in relation to one another in the movement apparatus and the setting can be fixed in a predetermined position. The setting can also be changed in an automated fashion during running operation in order to obtain a movement about a further dimension by this additional adjustment movement; in particular, this can obtain a three-axis movement.

Further, the post-exposure apparatus according to the present disclosure can be developed by means of a sealable housing that defines a fluid-tight interior in which the product produced by stereolithography is received, wherein, preferably, the interior is fillable with a gas or a liquid. By arranging the produced product in a fluid, i.e., a gas or liquid, it is possible to avoid a partial or complete prevention of the post-exposure effect by the radiation, which may occur, for example, by the presence of oxygen at the surface of the product and which may block or reduce cross-linkage. In particular, better thermal dissipation from the product can also be obtained by selecting a liquid or gas with a high heat transfer and a high heat capacity so as to reduce the temperature increase caused by the irradiation. Here, the housing in which the fluid and the product are arranged can be open; this is preferred, in particular, if the housing is stationary. A stationary embodiment of the housing can be achieved by virtue of the housing serving as a reception apparatus and the radiation source implementing the movement along the two guide paths. Likewise, the housing can implement a movement along one guide path, which ensures a reliable running alignment of the housing opening such that no fluid can emerge from the housing, with the movement along the other guide path being implemented by the radiation source. As an alternative thereto or in combination therewith, the housing can also be stationary and the reception apparatus can be arranged in the housing and can be provided within the housing together with the first and second guide path of the movement apparatus. In this case, the reception apparatus carries out a movement along one or two guide paths within the stationary housing and the radiation source can correspondingly be moved along one guide path or be stationary. In particular, this embodiment can be developed by means of a vacuum source which has a fluid connection to the fluid-tight interior in order to produce a vacuum in the interior. This facilitates implementing the post-exposure process in the interior in a vacuum and, as a result of this, avoiding or at least reducing the negative effect of oxygen from the surroundings. Here, it should be understood that the vacuum source can be provided by an apparatus-internal vacuum producer, but can likewise be provided by a vacuum connector present at the apparatus, said vacuum connector being embodied to connect an external vacuum producer or store in a fluid-tight manner and connect the latter to the interior.

According to a further preferred embodiment, provision is made of a heat radiation source for supplying to and/or dissipating heat from a product situated in the interior. By way of example, such a heat source can be embodied as an infrared radiation source for heating the product during the post-exposure process. Such a heat radiation source can likewise be embodied as a coolant for receiving thermal radiation of the product and thereby bringing about cooling of the product. In particular, the thermal radiation source can be switchable in order to alternatively bring about an elevation or a reduction in the temperature of the product during the post-exposure.

Still another aspect of the present disclosure relates to a method for solidifying products produced by stereolithography, including the steps of: irradiating the product produced by stereolithography with a solidifying radiation from a radiation source and moving the product relative to the radiation source, wherein, according to the disclosed method, the product carries out a movement that is composed of a movement along a first guide path and a movement along a second guide path that differs from the first.

The method can be developed by virtue of the second guide path being guided along the first guide path.

The method can be further developed by virtue of the first guide path being a first circular path about a first axis of rotation and the second guide path rotating about the first axis of rotation and said second guide path preferably being a second circular path about a second axis of rotation.

The method can be developed by virtue of the first guide path and the second guide path guiding the product independently of one another.

The method can be developed by virtue of the product being arranged within a spherical surface and the first guide path being defined by a first roll, which is rotatably mounted about a first axis and which is in contact with the spherical guide surface, and the second guide apparatus being defined by a second roll, which is rotatably mounted about a second axis that is arranged obliquely to the first axis, which is in contact with the spherical guide surface and on which the guide element rolls.

The method can be developed by virtue of the first guide path being a first circular path about a first axis of rotation and/or the second guide path being a second circular path about a second axis of rotation that extends obliquely to the first axis of rotation.

The method can be developed by virtue of the radiation being emitted from fewer than five, preferably fewer than three, in particular, a single radiation source and, accordingly, the stereolithographic product being irradiated from fewer than five, preferably fewer than three, and, in particular, only one direction.

The method can be developed by virtue of the radiation intensity being captured and regulated.

The method can be developed by virtue of the relative movement along the first and/or the second guide path being implemented by means of an automated drive.

The method can be developed by virtue of the relative movement along the first and second guide path being transferred onto the product from a single drive unit via a first and a second transmission device and by virtue of, preferably, the transmission ratio between the first and the second transmission apparatuses being adjustable between a first value and a second value.

The method can be developed by virtue of the relative movement along the first guide path being carried out from a first drive unit of the drive apparatus and the relative movement along the second guide path being carried out from a second drive unit of the drive apparatus.

The method can be developed by virtue of the speed of the movement along the first or second guide path being set between two speeds and/or the direction of the first or the second guide path being set between two directions.

The method can be developed by virtue of the product being immersed into a fluid during the irradiation thereof.

In relation to the method according to the disclosure and the development forms in respect thereof, reference is made to the explanation made above in relation to the apparatus according to the disclosure and the developments thereof. The variations, advantages, and functions explained in conjunction with the apparatus are applicable in the same way and in a corresponding manner to the methods and method developments corresponding thereto. It should be understood that the method according to the disclosure can preferably be carried out using the apparatus according to the disclosure; however, it could also be carried out with other apparatuses in a different, more or less automated way.

The movement speed of the product in the post-exposure apparatus can be predetermined and can be constant or variable, in particular controllable. Preferably, a minimum speed is defined and the latter is not undershot during the post-exposure process such that the irradiation and heating is not too strong locally. In the case of rotating movements, the minimum speed can be implemented, for example, by a rotational speed of at least 5 revolutions per minute, preferably 10 revolutions per minute, and the respective axis of rotation of the drive/drives. In the case of changing rotational speeds, the minimum or the average rotational speed may preferably not drop below the minimum rotational speeds.

### BRIEF DESCRIPTION OF THE DRAWINGS

Preferred embodiments of the invention are explained on the basis of the attached

Figures. In the Figures:

FIG. 1 is a schematic frontal view of a first embodiment of a post-exposure apparatus according to the present disclosure;

FIG. 2 is a schematic frontal view of a second embodiment of the post-exposure apparatus according to the present disclosure;

FIG. 3 is a side view of the embodiment according to FIG. 2;

FIG. 4 is a schematic frontal view of a third embodiment of the post-exposure apparatus according to the present disclosure;

FIG. 5 is a side view of the embodiment according to FIG. 4;

FIG. 6 is a schematic frontal view of a fourth embodiment of the post-exposure apparatus according to the present disclosure;

FIG. 7 is a schematic frontal view of a fifth embodiment of the post-exposure apparatus according to the present disclosure; and

FIG. 8 is a schematic frontal view of a sixth embodiment of the post-exposure apparatus according to the present disclosure.

### DETAILED DESCRIPTION OF THE PREFERRED EMBODIMENTS

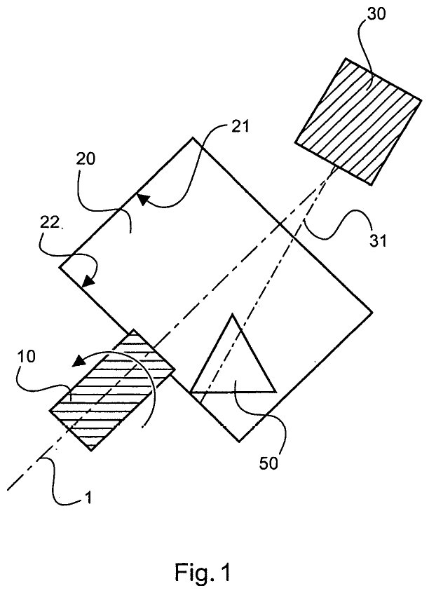

As referenced in the Figures, the same reference numerals may be used herein to refer to the same parameters and components or their similar modifications and alternatives. For purposes of description herein, the terms “upper,” “lower,” “right,” “left,” “rear,” “front,” “vertical,” “horizontal,” and derivatives thereof shall relate to the present disclosure as oriented in FIG. 1. However, it is to be understood that the present disclosure may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

With reference to FIG. 1, a post-exposure apparatus according to the invention comprises a rotatably mounted rotational shaft 10, which rotates about an axis of rotation 1. A drum 20 with a drum wall 21 is attached to the rotational shaft 10, said drum being made to rotate by the rotational shaft. The axis of rotation 1 is inclined at 45° in relation to the direction of gravity.

The drum wall is embodied as a cylindrical wall and it defines a drum interior. A component 50 produced by stereolithography is arranged in the drum interior. On account of the inclined position of the axis of rotation, the component 50 is situated in the lower right-hand corner of the drum 20.

A light source 30 is installed above the drum 20 in a stationary manner and it emits light radiation into the interior of the drum 20. The light radiation enters into the drum along a beam axis 31. The beam axis is directed to the lower right-hand corner of the drum, in which the component 50 is situated on account of gravity. The beam axis 31 extends obliquely to the axis of rotation 1.

If the drum is made to rotate about the axis of rotation 1 by way of the rotational shaft 10, the component 50 rolls on a drum base 22 and the drum wall 21 in an undetermined guide. In the process, the component is continuously irradiated by the light source 30 and cures as a result thereof.

The drum is preferably coated with an elastic protection at the inner surface of the drum wall 21 and the base area 22 in order to avoid damage to the component during this rolling process. As an alternative thereto, or additionally, the drum can be filled with a fluid, in particular a liquid, in order to thereby damp the rolling movement and prevent damage to the component by mechanical influences. Furthermore, the use of such a fluid is suitable for dissipating heat from the component.

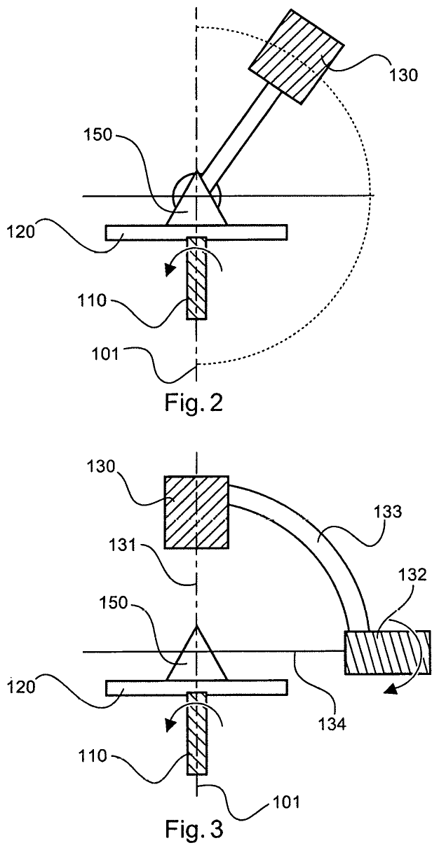

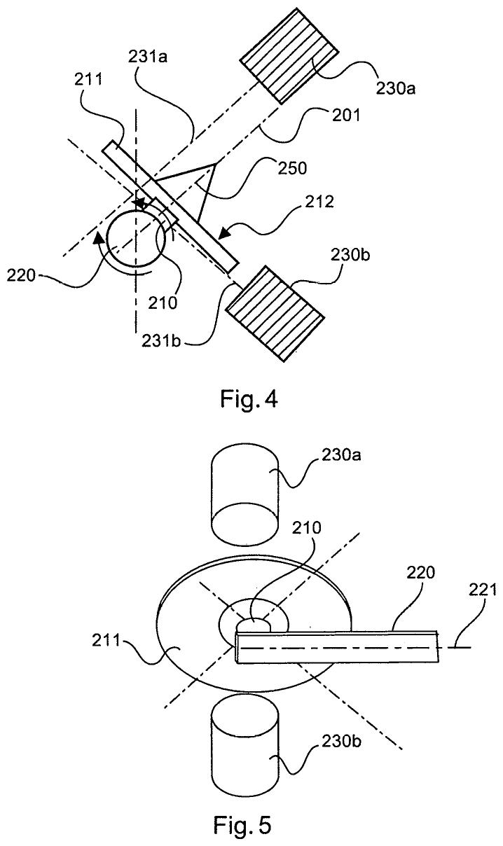

FIGS. 2 and 3 show a second embodiment, in which a component 150 is fastened to a rotary plate 120. The rotary plate 120 is rotatably mounted by means of a drive shaft 110 about an axis of rotation 101 and it can be made to rotate by means of a drive unit (not illustrated). The rotary plate 120 of this embodiment, just like the rotary plates 211, 311, 411 of the embodiments according to FIGS. 4 to 7, is radiation-transmissive. Here, radiation-transmissive should be understood to mean that the rotary plate 120 is transmissive, in particular, to the wavelength ranges of the radiation required for the post-exposure effect, i.e., the cross-linking or curing, in particular. The axis of rotation 101 is perpendicular, i.e., parallel, to the direction of gravity but could likewise be aligned obliquely in relation to the direction of gravity.

A light source 130 is pivotably mounted about a pivot axis 134, which is aligned horizontally. The light source 130 is connected to a pivot shaft 132 by means of a pivot arm 133.

The radiation direction 131 of the light source 130 is aligned on the component and it lies in a plane in which the axis of rotation 101 lies, too, at each pivot angle of the light source 130. The beam axis 131 of the light source and the alignment of the pivot axis 134 of the light source are such that the beam axis 131 of the light source is aligned onto the component at each pivot angle of the light source 130. Here, the beam axis 131 of the light source 130 preferably describes an angle of up to 360° , in particular up to 180° .

Pivot axis 134 of the light source and axis of rotation 101 of the rotary plate intersect at a point. Preferably, the beam axis 131 of the light source also intersects this point.

In a preferred variant of this embodiment, a drive source, which brings about the rotation of the pivot shaft 132, is actuated in such a way that a changeable rotational speed of the pivot shaft 132 is brought about. In particular, the rotational speed can be smallest in the case of a perpendicular position of the radiation axis 131 in relation to the axis of rotation 101 of the rotary plate and it can increase toward the positions at which the radiation axis 131 is parallel to the axis of rotation 101.

The embodiment shown in FIGS. 4 and 5 comprises a rotary plate 211, on which a component 250 produced by stereolithography is fastened. The rotary plate 211 is fastened to a shaft 210 that is rotatably mounted about an axis 201. The rotary plate 211 rotates continuously about this axis 201 by means of a drive of the shaft 210 about the axis 201.

The shaft 210 is fastened to a pivot arm 220 and rotatably mounted on said pivot arm.

The pivot arm 220, in turn, is pivotably mounted about a pivot axis 221 and it can carry out a reciprocating movement of 60° in a range of −30° to +30° in relation to the vertical about this pivot axis 221. The pivot axis 221 is stationary. As a result, the rotary plate 211 is pivoted back and forth about the pivot axis 221 lying in the horizontal, this being superposed on its rotation about its axis of rotation 201.

The embodiment according to FIGS. 4 and 5 comprises an irradiation apparatus having two light sources 230a, 230b, both of which are fastened in stationary fashion to the apparatus. The light sources 230a, 230b have a radiation direction 231a, 231b, which is directed to a point slightly above the point of intersection of the axis of rotation 201 and the pivot axis 221 and which lies vertically above this point of intersection. The vertical distance between the point of intersection of the radiation axes 231a, 231b and the point of intersection of the axis of rotation 201 with the pivot axis 221 approximately corresponds to the distance between the surface 212 of the rotary plate, on which the component is fastened, and the pivot axis 221.

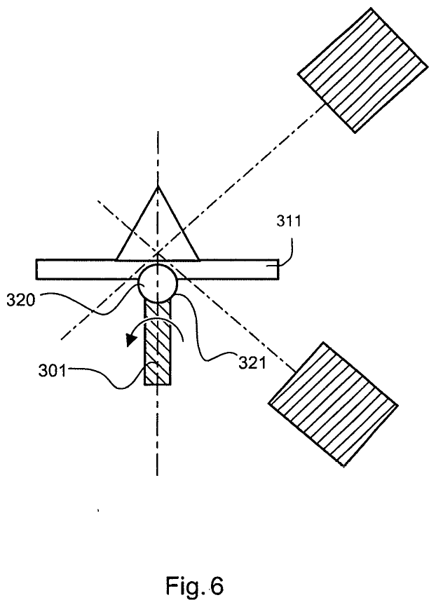

FIG. 6 shows a fourth embodiment of the present disclosure, which, in principle, has an embodiment with the same construction as the third embodiment. The variation of the fourth embodiment in relation to the third embodiment consists of the rotation about the axis of rotation 301 being superposed on the pivot movement about the pivot axis 321 in this fourth embodiment and the axis of rotation 301 therefore being stationary, and the pivot axis 321 of the pivot arm 320 being arranged at a smaller distance from the surface of the rotary plate 311.

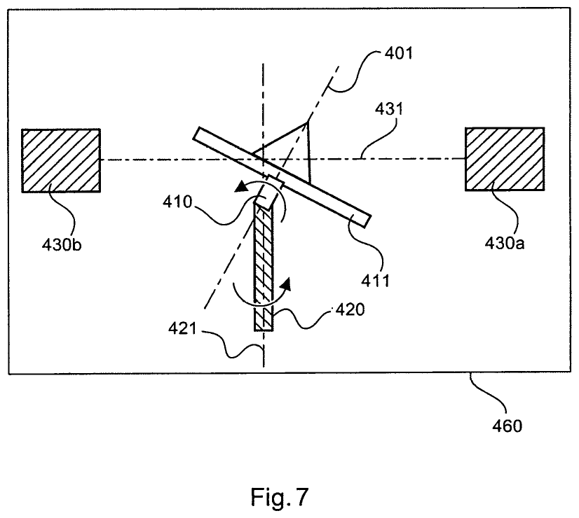

FIG. 7 shows a fifth embodiment of the present disclosure in which, likewise, a rotary plate 411 is fastened to a pivot shaft 410 and there is a superimposed movement about an axis of rotation 401 of the rotary plate and a pivot axis 421 of a pivot shaft 426. As a variation to the third and fourth embodiment, the axis of rotation 401 and the pivot axis 421 do not lie at right angles to one another but instead lie at an angle of approximately 30° to one another. The fifth embodiment has a radiation apparatus 430a, 430b, which is formed by a first radiation source 430a and a second radiation source 430b. Both radiation sources 430a, 430b are installed in a stationary fashion. The radiation source 430a lies on the axis of rotation 401; the radiation source 430b lies on radiation axis 431 that differs therefrom.

Both the radiation sources 430a, 430b and the movement apparatus, which are formed by the rotary plate 411, the rotary shaft 410, and the pivot shaft 420, are arranged within a mirrored chamber 460 that is filled with a liquid. The mirrored chamber 460 is cubic and has a mirrored surface on all six internal surfaces. In principle, other constructions deviating from this cubic form may also be advantageous in certain applications, for example, other polygonal forms with eight corners or more than eight corners or a spherical form.

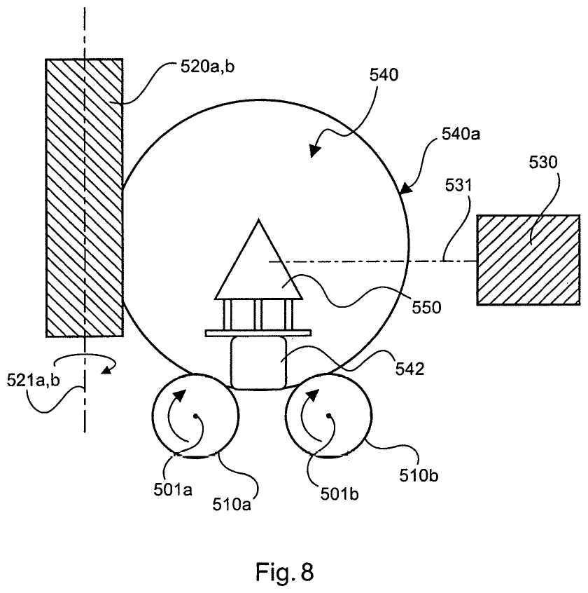

FIG. 8 shows a sixth embodiment of the present disclosure. The illustrated embodiment has a reception apparatus 540, which is formed by a hollow sphere 540a with a closable aperture (not shown) and a fastening body 542 fastened to the inner surface of the sphere. A component 550 produced by stereolithography is fastened to the fastening body 542.

The outer surface of the sphere 540 is mounted on two rolls 510a, 510b, whose axes of rotation 501a, 501b extend parallel to and at a distance from one another. By rotating the rolls 510a, 510b, the sphere is made to rotate about a first axis of rotation that extends parallel to the axes of rotation 501a, 501b and through the center of the sphere 540.

A second pair of rolls 520a, 520b is in contact with the outer surface of the sphere 540. This second pair of rolls 520a, 520b is rotatably mounted about two corresponding axes of rotation 521a, 521b, which are likewise parallel to and at a distance from one another. The second pair of rolls 520a, 520b brings about a rotation of the sphere 540 about a second axis that extends parallel to the axes of rotation 521a, 521b and through the center of the sphere 540. As a result of this, the sphere experiences a two-axis movement about both axes of rotation, which emerges from an addition of the sphere rotations that are transferred by the rolls 510a, 510b and 520a, 520b onto the surface of the sphere.

A single irradiation apparatus 530 is provided in a stationary fashion and it has an irradiation axis 531, which is directed to the center of the sphere 540.

It will be understood by one having ordinary skill in the art that construction of the described present disclosure and other components is not limited to any specific material. Other exemplary embodiments of the disclosure disclosed herein may be formed from a wide variety of materials, unless described otherwise herein.

For purposes of this disclosure, the term “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that many modifications are possible, e.g., variations in sizes, dimensions, structures, shapes and proportions of the various elements, values of parameters, mounting arrangements, use of materials, colors, orientations, etc. without materially departing from the novel teachings and advantages of the subject matter recited. For example, elements shown as integrally formed may be constructed of multiple parts or elements shown in multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of the wide variety of materials that provide sufficient strength or durability, in any of the wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is to be understood that variations and modifications can be made on the aforementioned structure and method without departing from the concepts of the present disclosure, and further it is to be understood that such concepts are intended to be covered by the following claims unless these claims by their language expressly state otherwise.

1.-27. (canceled)

28. A post-exposure apparatus for products produced by stereolithography comprising:
a reception apparatus for receiving a product produced by stereolithography;
a radiation apparatus for irradiating a product received in the reception apparatus; and
a movement apparatus coupled between the reception apparatus and the radiation apparatus for producing a relative movement between the product received in the reception apparatus and the radiation apparatus;
wherein the movement apparatus comprises a first guide apparatus for guiding the relative movement along a first guide path and a second guide apparatus for guiding the relative movement along a second guide path that differs from the first guide path.

29. The post-exposure apparatus as claimed in claim 28, wherein the second guide apparatus is coupled to the first guide apparatus and guided by the first guide apparatus.

30. The post-exposure apparatus as claimed in claim 29, wherein the first guide apparatus comprises a first axis of rotation and the second guide apparatus comprises a second axis of rotation, about which a rotatable bearing is provided between the reception apparatus and the radiation apparatus, and the second axis of rotation is guided in a manner rotatable about the first axis of rotation.

31. The post-exposure apparatus as claimed in claim 28, wherein the first guide apparatus is coupled between the reception apparatus the and radiation apparatus, the second guide apparatus is coupled between the reception apparatus and the radiation apparatus, and the first and second guide apparatus directly cause a mutually independent guide between the reception apparatus and the radiation apparatus.

32. The post-exposure apparatus as claimed in claim 31, wherein:
the reception apparatus comprises a guide element having a spherical guide surface that surrounds an interior and a fastening apparatus arranged in the interior for fastening the stereolithographic component;
the first guide apparatus comprises a first roll which is mounted to be rotatable about a first axis and which is in contact with the spherical guide surface upon which the guide element rolls; and
the second guide apparatus comprises a second roil which is mounted to be rotatable about a second axis that is arranged obliquely to the first axis and which is in contact with the spherical guide surface upon which the guide element rolls.

33. The post-exposure apparatus as claimed in claim 28, wherein the first guide path is a first circular path about a first axis of rotation and the second guide path is a second circular path about a second axis of rotation which extends obliquely to the first axis of rotation.

34. The post-exposure apparatus as claimed in claim 28, wherein the radiation apparatus has fewer than five single radiation sources that irradiate the stereolithographic product from fewer than five directions.

35. The post-exposure apparatus as claimed in claim 34, wherein the radiation apparatus has fewer than three single radiation sources that irradiate the stereolithographic product from fewer than three directions.

36. The post-exposure apparatus as claimed in claim 35, wherein the radiation apparatus has a single radiation source that radiates the stereolithographic product from only one direction.

37. The post-exposure apparatus as claimed in claim 28, further comprising a radiation sensor for capturing the radiation intensity of the radiation source, wherein the radiation sensor is coupled by signaling to a radiation regulation unit that is embodied to regulate a radiation parameter of the radiation source and coupled by signaling to the radiation source.

38. The post-exposure apparatus as claimed in claim 28, wherein the movement apparatus comprises a drive apparatus for moving the reception apparatus along the first and the second guide path.

39. The post-exposure apparatus as claimed in claim 38, wherein the drive apparatus comprises a drive unit, a first transmission unit for coupling the drive unit to the reception apparatus for a movement along the first guide path, and a second transmission unit for coupling the drive unit to the reception apparatus for a movement along the second guide path, and wherein the first or second transmission unit is switchable between at least two different transmission ratios for changing the movement speed of the reception apparatus along the first or second guide path.

40. The post-exposure apparatus as claimed in claim 38, wherein the drive apparatus comprises a first drive unit for moving the reception apparatus along the first guide path and a second drive unit for moving the reception apparatus along the second guide path,

41. The post-exposure apparatus as claimed in claim 40, further comprising a drive control unit coupled by signaling to the first or the second drive unit and which controls the speed of the first or the second drive unit.

42. The post-exposure apparatus as claimed in claim 28, wherein the movement apparatus is configured such that a difference between the first and the second guide path is adjustable by virtue of the first guide path being defined by a first direction and the second guide path being defined by a second direction that is at an adjustable angle of between 0 and 180 in relation to the first direction.

43. The post-exposure apparatus as claimed in claim 28, wherein the reception apparatus comprises a sealable housing that defines a fluid-tight interior within which the product produced by stereolithography is received and within which a gas or a liquid may he received.

44. A method for solidifying products produced by stereolithography, including the steps of:
irradiating the product produced by stereolithography with a solidifying radiation from a radiation source; and
moving the product relative to the radiation source;
wherein the product carries out a movement that is composed of a movement along a first guide path and a movement along a second guide path that differs from the first guide path.

45. The method as claimed in claim 44, wherein the second guide path is guided along the first guide path.

46. The method as claimed in claim 45, wherein the first guide path is a first circular path about a first axis of rotation, the second guide path rotates about the first axis of rotation, and the second guide path is a second circular path about a second axis of rotation.

47. The method as claimed in claim 44, wherein the first guide path and the second guide path guide the product independently of one another.

48. The method as claimed in claim 47, wherein the product is arranged within a spherical guide surface and the first guide path is defined by a first roll rotatably mounted about a first axis and in contact with the spherical guide surface, and the second guide path is defined by a second roll rotatably mounted about a second axis that is arranged obliquely to the first axis, the second roll being in contact with the spherical guide surface.

49. The method as claimed claim 44, wherein the first guide path is a first circular path about a first axis of rotation and the second guide path is a second circular path about a second axis of rotation that extends obliquely to the first axis of rotation.

50. The method as claimed in claim 44, wherein the radiation is emitted from fewer than five radiation sources and the stereolithographic product is irradiated from fewer than five directions.

51. The method as claimed in claim 44, wherein the radiation intensity is captured and regulated.

52. The method as claimed in in claim 44, wherein the relative movement along the first or the second guide path is implemented by an automated drive,

53. The method as claimed in claim 52, wherein relative movement along the first and second guide path is transferred onto the product from a single drive unit via a first and a second transmission device and the transmission ratio between the first and the second transmission apparatus is adjustable between a first value and a second value.

54. The method as claimed in claim 52, wherein relative movement along the first guide path is carried out from a first drive unit of the drive apparatus and the relative movement along the second guide path is carried out from a second drive unit of the drive apparatus,

55. The method as claimed in claim 44, wherein the speed of the movement along the first or second guide path is set between two speeds or the direction of the first or the second guide path is set between two directions.

56. The method as claimed in claim 44, wherein the product is immersed into a fluid during the irradiation thereof.
